(19) United States
(12) Patent Application Publication
(10) Pub. No.: US 2025/0058527 A1
(43) Pub. Date: Feb. 20, 2025

(54) METHOD FOR THE LAYERED MANUFACTURING OF AT LEAST ONE OBJECT ON A ROUGHENED BASE ELEMENT

(71) Applicant: TRUMPF Laser- und Systemtechnik GmbH, Ditzingen (DE)

(72) Inventors: Valentin Blickle, Stuttgart (DE); Nicolai Essig, Renningen (DE)

(21) Appl. No.: 18/937,083

(22) Filed: Nov. 5, 2024

Related U.S. Application Data
(63) Continuation of application No. PCT/EP2023/059217, filed on Apr. 6, 2023.

(30) Foreign Application Priority Data
May 12, 2022 (DE) 10 2022 111 904.1

(51) Int. Cl. B29C 64/393; B29C 64/153; B29C 64/371; B33Y 30/00; B33Y 50/00

(52) U.S. Cl. CPC B29C 64/393; B29C 64/153; B29C 64/371; B33Y 30/00; B33Y 50/00

(57) ABSTRACT

A method for operating a system for layered manufacturing of an object on a base element includes A) arranging the base element on a piston plate, B) carrying out a preliminary measurement in the system, wherein a measurement pattern on an upper side of the base element is measured, C) based on data from the preliminary measurement, preparing and carrying out the layered manufacturing of the object, and A′), after the step A) and before the step B), in a treatment region of the base element, roughen a surface of the base element with a working laser in the system. In the step B), the measurement pattern includes a light pattern projected into the roughened treatment region, and/or an edge structure with a plurality of edges. At least a part of the plurality of edges of the edge structure is in the roughened treatment region.

### CROSS REFERENCE TO RELATED APPLICATIONS

This application is a continuation of International Application No. PCT/EP2023/059217 (WO 2023/217468 A1), filed on Apr. 6, 2023, and claims benefit to German Patent Application No. DE 10 2022 111 904.1, filed on May 12, 2022. The aforementioned applications are hereby incorporated by reference herein.

### FIELD

Embodiments of the present invention relate to a method for operating a system for layered manufacturing of at least one object on a base element by locally consolidating pulverulent material in a layer with a working laser.

### BACKGROUND

A method has been disclosed, for example, in WO 2019/086250 A1.

Layered manufacturing of objects by locally consolidating pulverulent material using high-energy beams (usually laser beams or electron beams) allows three-dimensional objects to be produced comparatively easily and quickly. Geometric limitations of conventional manufacturing processes such as milling or injection molding can be overcome in this regard. The layered manufacturing is often used for prototypes or for objects that are only produced in small quantities.

The object(s) are grown on a base element which is arranged on a movable piston plate of a piston. After each layer of the pulverulent material has been applied to the base element, the pulverulent material is locally consolidated with one or more high-energy beams. The piston plate with the piston is then lowered by one layer thickness, a new layer of pulverulent material is applied and locally consolidated, and so on.

To ensure good manufacturing quality in layered manufacturing, it is important that the base element on which the object(s) are manufactured is correctly aligned. It is also necessary that the high-energy beams are correctly aligned with the base element. Before manufacturing begins, a preliminary measurement is usually carried out in which a measurement pattern is measured on the upper side of the base element.

For example, as described in WO 2019/086250 A1, a measuring laser can be used to generate a measurement pattern of laser light on the base element, which is designed there as a flat substrate plate, which is then measured with a camera. The data from this preliminary measurement can be used, for example, to correct the position and/or orientation of the base element in order to prepare the subsequent manufacturing of the object(s).

DE 10 2018 219 301 A1 discloses measuring the position of a base element formed there as a preform by scanning the working beam over the preform with a scanner and detecting light scattered back into the scanner along the optical axis in a location-dependent manner. This allows an image of the preform to be obtained. Using this image, the working beam can then be correctly aligned to the preform during layered manufacturing.

The base elements, such as substrate plates or preforms, for the layered manufacturing of three-dimensional objects are often made of metal. Metals often have shiny (reflective) surfaces on which projected light patterns are often difficult to see and capture with a camera. When scanning the surface of a preform with a working laser that predominantly does not impinge on the surface perpendicularly, the amount of backscattered laser light along the optical axis is also quite small. In addition, unintentional light reflections on the reflective surface can overlie the measurement patterns and therefore interfere with their detection. Accordingly, in the case of reflective surfaces of the base element, the measurement patterns can often only be detected with insufficient contrast or incompletely, and the preparation of layered manufacturing is not reliably possible.

In the case of base elements with reflective surfaces, it is common practice to pre-treat them before the base element is arranged on the piston platform in the system for layered manufacturing. Typical pretreatments include sandblasting or brushing. This roughens the surface of the base element, which significantly increases the light scattering on the surface. The contrast in preliminary measurement is then improved and layered manufacturing can be prepared in a straightforward manner. However, sandblasting or brushing of the surface is comparatively complex and increases the cost of manufacturing.

WO 2015/040185 A1 also discloses applying reference markings to a calibration plate, forming laser markings on the calibration plate using the working laser of a 3D-printing system, and imaging the calibration plate using a camera. Scanner corrections are determined from the relative position of the laser markings with respect to the reference markings.

### SUMMARY

Embodiments of the present invention provide a method for operating a system for layered manufacturing of at least one object on a base element by locally consolidating pulverulent material in a layer with a working laser. The method includes A) arranging the base element on a movable piston plate, and B) carrying out a preliminary measurement in the system. A measurement pattern on an upper side of the base element is measured using a measuring device. The method further includes C) based on data from the preliminary measurement, preparing and carrying out the layered manufacturing of the at least one object on the base element, and A′), after the step A) and before the step B), in a treatment region of the base element, roughen a surface of the base element facing the working laser with the working laser in the system. The treatment region includes at least a part of the upper side of the base element. In the step B), the measurement pattern to be measured includes a light pattern which is at least partially projected into the roughened treatment region on the upper side of the base element, and/or an edge structure on the upper side of the base element with a plurality of edges. At least a part of the plurality of edges of the edge structure is in the roughened treatment region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a first embodiment of a system for the layered manufacturing of an object with a measuring device comprising a camera for carrying out the method according to embodiments of the invention;

FIG. 2 shows a schematic view of a second embodiment of a system for the layered manufacturing of an object with a measuring device, comprising a zero-dimensional photodetector, for carrying out the method according to embodiments of the invention;

FIG. 3 shows a flow chart of a method according to embodiments of the invention, in which, after a preliminary measurement, the layered manufacturing of the object is prepared and carried out;

FIG. 4 shows a flow chart of a method according to embodiments of the invention, in which feedback control is carried out after a preliminary measurement;

FIG. 5 shows an experimental image of a flat substrate plate which has a surface that has been partially roughened with the working laser, with a light pattern being projected onto the substrate plate, according to some embodiments; and

FIG. 6 shows an experimental image of a preform which has a surface that has been partially roughened with the working laser, according to some embodiments.

### DETAILED DESCRIPTION

Embodiments of the invention can enable an improved contrast in the preliminary measurements.

According to embodiments of the invention, a method of for operating a system for the layered manufacturing of at least one object on a base element by locally consolidating pulverulent material in a layer with a working laser includes the following steps:
Step A) the base element is arranged on a movable piston plate,
Step B) a preliminary measurement is carried out in the system, with a measuring device being used to measure a measurement pattern on the upper side of the base element,
Step C) based on data from the preliminary measurement, the layered manufacturing of at least one object on the base element is prepared and carried out,
   after step A) and before step B) a step A′) takes place, and in
   step A′), in a treatment region of the base element, a surface of the base element facing the working laser is roughened with the working laser in the system, the treatment region comprising at least part of the upper side of the base element,
   and in step B) the measurement pattern to be measured
comprises a light pattern which is at least partially projected into the roughened treatment region onto the upper side of the base element, and/or
comprises an edge structure of the base element on the upper side of the base element with a plurality of edges, with at least part of the edges of the edge structure being in the roughened processing region.

According to embodiments of the invention, the base element is pretreated in the system for layered manufacturing (also called 3D-printing system) with the working laser. The working laser roughens the surface of the base element in a treatment region, at least over a part of the upper side of the base element, so that the diffuse light scattering in the treatment region is increased. The measurement pattern to be measured is more visible on the roughened surface of the treatment region or against the background of the roughened surface of the treatment region than on an untreated, in particular reflective surface.

Light patterns cast onto the roughened surface are clearly visible on the roughened surface from a wide solid angle range and can also be easily detected, in particular with a camera. Likewise, edges of any edge structure of the base element become more visible or easier to detect against the roughened surface. Another advantage is that it avoids highlights on the surface of the base element, which can impair the contrast when detecting the measurement pattern during preliminary measurement.

Overall, improved pattern recognition, in particular shape recognition and edge recognition, can be achieved by embodiments of the invention. According to embodiments of the invention, the measurement of the measurement patterns can be carried out with high contrast and, accordingly, very reliably and reproducibly.

According to embodiments of the invention, the roughening of the surface of the processing region is carried out by the working laser (or possibly a plurality of working lasers, if available). The working laser is used to locally consolidate the powder layers during layered manufacturing and, according to embodiments of the invention, also for roughening the surface of the base element in the treatment region for the preliminary measurement, and is therefore used twice. A separate device for roughening the surface of the base element (such as a sandblasting station or a brushing station) is not necessary, which makes the procedure according to embodiments of the invention simple and cost-effective.

In addition, it is possible to easily adapt the roughening with the working laser to a particular type of base element, for example to the material (often copper, steel, aluminum, etc.) or the preceding manufacturing steps (often milling, sawing, etc. and subsequent polishing) or the surface geometry (flat substrate or preform with edge structure). For example, the laser power or feed speed of the working laser or a melt track spacing can be adjusted. Since the 3D-printing system also has the equipment to observe the measurement pattern, the treatment success (discernible by the contrast of the measurement pattern) can be checked immediately after roughening of the surface, which enables quick and easy feedback for optimizing the laser parameters for roughening the base element in the treatment region.

The data from the preliminary measurement can be used to determine the position and/or orientation (tilt) of the base element, and thus bring about a corresponding position correction and/or orientation correction of the base element, and/or to adjust (calibrate) the scanner of the working laser (or the scanners of a plurality of working lasers, if available). This prepares the layered manufacturing of at least one object. The actual layered manufacturing of the object (each with application of a powder layer, local consolidation with the working laser, lowering the piston by one layer height, application of the next powder layer, etc.) can then be carried out using the working laser (or working lasers, if present).

The measurement pattern may in particular comprise a projected triangulation pattern. A light pattern as a measurement pattern is typically generated by a separate measuring laser (usually a laser diode); but it is also possible to generate a light pattern with the working laser. When the light pattern is projected, the surface of the base element is not changed (in particular, it is not melted).

The base element (also called build platform) is typically a flat substrate plate or a preform with a preform structure that forms a relief on the upper side of the base element.

In step A′), the surface of the base element is melted, in particular a large number of small melt beads are produced on the surface, which overall cause diffuse light scattering.

A variant of the method according to embodiments of the invention is preferred, according to which,
after step B), a step B′) takes place, wherein in
step B′) for image information of the measured measurement pattern which is contained in the data from the preliminary measurement, a contrast measurement value CMV is determined and compared with a contrast limit value CLV,
and steps A′), B) and B′) are repeated if: CMV<CLV. This makes it easy to ensure sufficient contrast of the measurement pattern for the preparation of layered manufacturing. In particular, the contrast value may comprise a brightness difference value at the border of a light pattern (illuminated region vs. non-illuminated region) or at an edge (edge line vs. adjacent region) or an average of such brightness difference values. It should be noted that generally the approximate position of the measurement pattern on the base element is known in advance so that corresponding borders or edges are usually easy to find and identify.

A further development of this variant is preferred in which feedback control of laser parameters of the working laser is carried out during roughening of the surface facing the working laser in step A′) by repeating steps A′), B) and B′). During feedback control, an optimization of the laser parameters or the contrast (determined by means of the contrast measurement value) is possible in a simple manner according to embodiments of the invention. The treatment of the surface and the determination of contrast can be carried out by means of the 3D-printing system; in particular, it is not necessary to insert or remove the base element for the feedback.

Also preferred is a further development according to which, when step A′) is repeated, a laser speed v_{L} and/or a laser power P_{L} and/or a melt track spacing A_{L} of the working laser is changed in relation to a previous step A′). These laser parameters are easy to control and usually allow the surface roughening of the base element to be easily influenced.

A variant is also preferred in which the system has a heating apparatus for the base element, by which the base element is preheated before the layered manufacturing of the at least one object is started, and steps A′) and B) take place during the preheating of the base element by the heating apparatus. This means that step A′) and step B) (and possibly also step B′) can be carried out in a time-saving manner and, in particular, without extending the non-productive time.

Also advantageous is a variant in which the system has a gas-tight build chamber in which a protective gas atmosphere is configured before the start of the layered manufacturing of the at least one object, and steps A′) and B) take place during the configuration of the protective gas atmosphere. This also allows steps A′) and B) (and possibly also step B′) to be carried out in a time-saving manner and, in particular, without extending the non-productive time.

Also advantageous is a variant in which the measuring device comprises a camera which, during the preliminary measurement, records at least one image of the measurement pattern on the upper side of the base element. This variant is easy to implement and has been tried and tested in practice. The camera can be used to quickly and easily detect light patterns in particular.

In an alternative variant,
the measuring device comprises a zero-dimensional photodetector, in particular a photodiode,
the measuring device also uses the working laser and a scanner device of the working laser,
and at least one image of the measurement pattern on the upper side of the base element is recorded by scanning the upper side of the base element with a measuring laser beam generated by the working laser and detecting laser light which is scattered back through the scanner device into the zero-dimensional photodetector from an impingement point of the measuring laser beam on the upper side of the base element. This procedure (“laser camera”) can generate a fairly accurate image of the upper side of the base element. A separate conventional camera is not necessary. In particular, preform structures can be imaged with high accuracy and with reference to the scanner coordinate system. When the surface is scanned with the working laser as part of the preliminary measurement, the surface of the base element is not changed, and in particular it is not melted.

A variant is also preferred in which the data from the preliminary measurement comprise information about
a position of the base element relative to the piston plate or to the rest of the system and/or
a tilting of the base element relative to the piston plate or to the rest of the system and/or
three-dimensional structures of the base element, in particular the position of the three-dimensional structures relative to the piston plate or to the rest of the system. With this information, layered manufacturing on the base element can usually be adequately prepared, in particular so that the three-dimensional objects grow correctly on the base element with respect to position and orientation. The data from the preliminary measurement can be used in particular to calibrate or adjust the scanner system of the working laser (or the scanner systems of the working lasers).

A variant in which the base element is designed as a flat substrate plate is also preferred. Typically, in this variant the measurement pattern is chosen as a light pattern. The base plate can be checked or corrected for correct position and/or appropriate orientation (tilt position) during the preliminary measurement. Universal three-dimensional objects can be grown on the flat substrate plate, if necessary also on supports.

Also preferred is a variant in which the base element is designed as a preform, wherein a preform structure is incorporated into the preform on the upper side of the base element with a plurality of edges,
in particular wherein the preform structure serves at least partially as an edge structure of a measurement pattern to be measured. This allows complex structures to be manufactured for many applications. The preform is manufactured conventionally (not using 3D printing), for example by bending processes and/or cold forming and/or casting processes and/or milling processes.

Embodiments of the present invention also include a system for layered manufacturing of at least one object on a base element by locally consolidating pulverulent material in a layer with a working laser,
configured to carry out a method according to embodiments of the invention described above, in particular wherein the system is configured to automatically carry out at least steps A′), B) and C). The system can be used to carry out preliminary measurements with good contrast in a simple and cost-effective manner, even if the base part is still highly reflective (shiny) after previous manufacturing steps that have taken place outside the system, and to reliably carry out 3D-printing with high manufacturing precision. For the automated performance of process steps, the system typically has an electronic control device.

The use of an apparatus according to embodiments of the invention described above in a method according to embodiments of the invention described above also falls within the scope of the present invention. In the system, the roughening of the surface of the base element in the treatment region can be carried out with the working laser, and then the layered manufacturing of the at least one three-dimensional object can be carried out in the system using the working laser for locally consolidating the pulverulent material.

Further advantages of the embodiments of the invention arise from the description and the drawings. Similarly, the features mentioned above and the features still to be explained may each be used on their own or together in any desired combinations according to embodiments of the invention. The embodiments shown and described should not be understood as an exhaustive list.

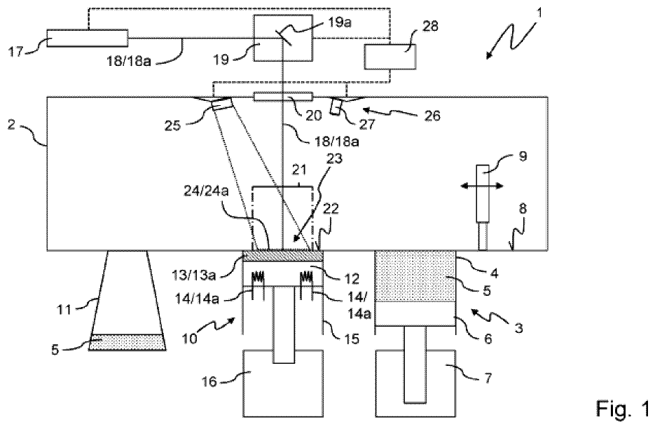

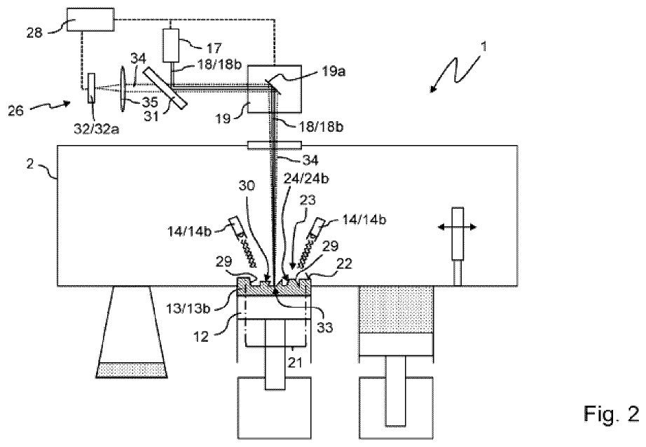

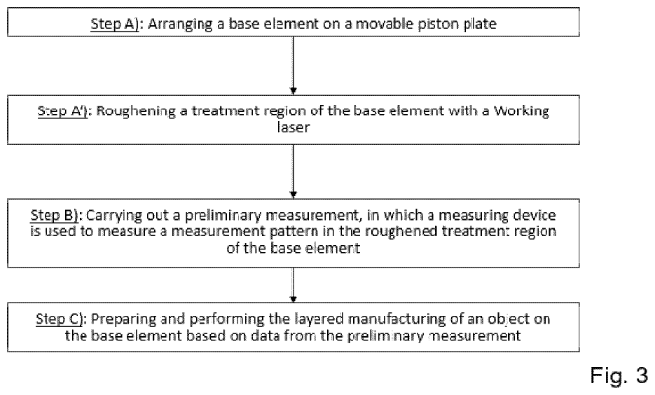

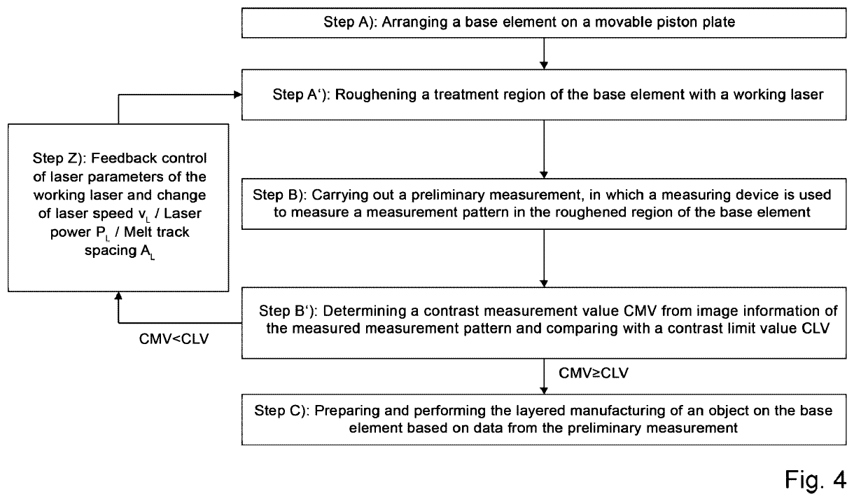

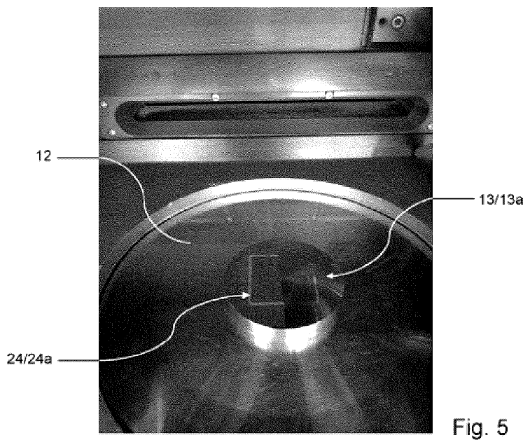

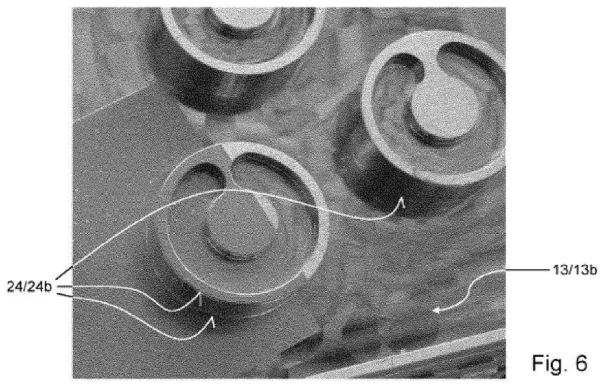

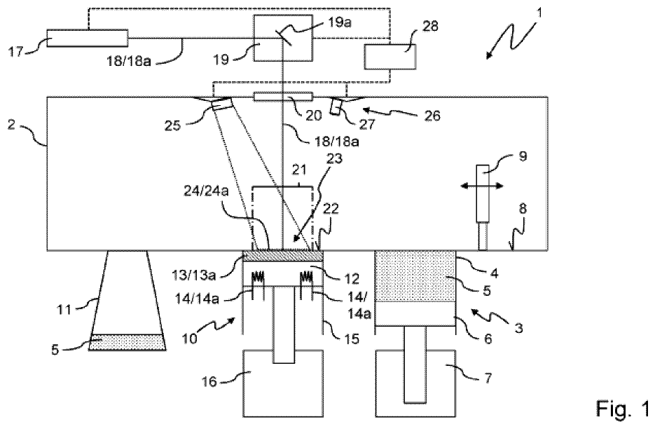

FIG. 1 shows a schematic side view of a first embodiment of a system 1 for the layered manufacturing of an object (not shown in detail), in which the system 1 is suitable for carrying out the method according to embodiments of the invention.

System 1 comprises a gas-tight build chamber 2. A protective gas atmosphere (inert gas atmosphere) can be configured in the gas-tight build chamber 2. The protective gas atmosphere is configured before the layered manufacturing of the object begins. Nitrogen or a noble gas such as argon can be used as a protective gas (inert gas).

A powder cylinder arrangement is connected to the gas-tight build chamber 2 3. The powder cylinder arrangement 3 has a powder cylinder 4 for a pulverulent material 5 (dotted area). The object is manufactured from the pulverulent material 5, for example by sintering or melting. By gradually raising a powder piston 6 with a first lifting device 7 a small amount of the pulverulent material 5 is raised above the level of a bottom 8 of the gas-tight build chamber 2. A slider 9 can be used to take this small amount of pulverulent material 5 to a build cylinder arrangement 10. Excess pulverulent material 5 can be swept by the slider 9 into a collecting container 11 connected to the gas-tight build chamber 2.

The build cylinder arrangement 10 is also connected to the gas-tight build chamber 2. The build cylinder arrangement 10 has a movable piston plate 12 on which a base element 13, a flat substrate plate 13a in the embodiment shown here, is arranged. The object is manufactured on the base element 13. In the embodiment shown here, a heating apparatus 14 is arranged in the movable piston plate 12. The heating apparatus 14 is formed here with electrical heating coils 14a. The heating apparatus 14 can be used to preheat the base element 13 before the layered manufacturing of the object. The base element 13 can be moved vertically with the movable piston plate 12 in a main body 15 via a second lifting device 16.

The system 1 also comprises a working laser 17. The working laser 17 can provide laser beams 18 for different purposes. In the embodiment shown here, the working laser 17 provides a preparation laser beam 18a (solid line) and a processing laser beam (not shown here in detail). The preparation laser beam 18a can be used to prepare the base element 13 for a preliminary measurement. The processing laser beam can be used for the layered manufacturing of the object. The laser beam 18 is directed onto a scanner device 19 of the working laser 17. The scanner device 19 can be used to direct the laser beam 18 onto the base element 13. The scanner device 19 may comprise one or more movable mirrors 19a with which the alignment of the laser beam 18 with the base element 13 can be changed. The laser beam 18 is directed via a window 20 into the gas-tight build chamber 2.

According to embodiments of the invention, before the layered manufacturing of the object on the base element 13 is started, the base element 13 is roughened by the working laser 17 on an upper side 23 of the base element 13. For this purpose, the base element 13 is roughened in a treatment region 21 by the processing laser beam 18a on a surface facing the preparation laser beam 18a 22 on the upper side 23 of the base element 13. In the example illustrated here, only a part of the upper side 23 of the base element 13 is covered by the roughened treatment region 21 of the base element 13.

Furthermore, after roughening of the treatment region 21 of the base element 13, a measurement pattern 24 is measured as part of a preliminary measurement (before the manufacturing of the layers is started). In the example illustrated here, the measurement pattern 24 is emitted (projected) as a light pattern 24a into the roughened treatment region 21 onto the upper side 23 of the base element 13. Only by roughening the surface 22 of the flat substrate plate 13a does the light pattern 24a become sufficiently clearly discernible on the base element 13 (in other words, the contrast of the light pattern 24a improves as a result of the roughening), so that the light pattern 24a can be easily detected and processed, for example, by an image processing algorithm. The light pattern 24a is generated by a projector 25 (for example a measuring laser comprising a laser diode). In the preliminary measurement, the measurement pattern 24 is measured on the upper side 23 of the base element 13 via a measuring device 26. In the embodiment shown here, the measuring device 26 comprises a camera 27. For the preliminary measurement, the camera 27 takes at least one image of the light pattern 24a.

The image data from camera 27 are transmitted to a control unit 28 and processed. In particular, the data from the preliminary measurement may comprise information about the position and tilt of the base element 13 relative to the piston plate 12 or to the system 1. The data from the preliminary measurement serve as a basis for the preparation and performance of the layered manufacturing of the object on the base element 13. The control unit 28 transmits control commands to connected components which take into account the data from the preliminary measurement, and the layered manufacturing of the object can be carried out on the base element 13.

In FIG. 1, transmission lines leading from the working laser 17, the scanner device 19, the projector 25 and the measuring device 26 to the control unit 28 are shown as dashed lines. It should also be noted that the control unit 28 also controls the first lifting device 7, the slide 9, the heating apparatus 14 and the second lifting device 16 (the transmission lines are not shown in detail here for the sake of clarity).

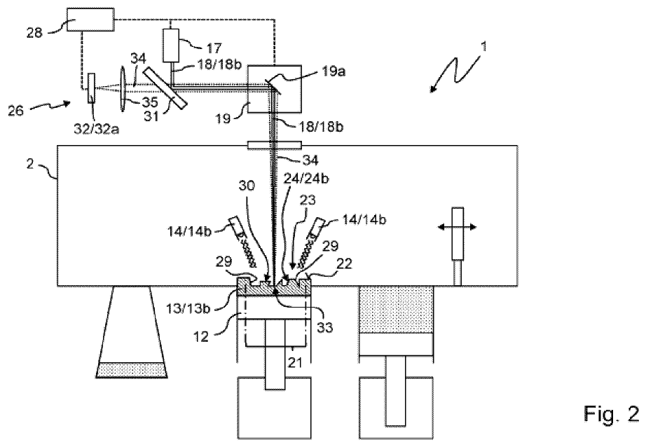

FIG. 2 shows, in a schematic side view, a second embodiment of a system 1 for the layered manufacturing of an object (not shown in detail), in which the system 1 is suitable for carrying out the method according to embodiments of the invention. The second embodiment of the system 1 shown here is constructed similarly to the first embodiment of the system 1 from FIG. 1, which is why only the essential differences are explained in FIG. 2.

In the embodiment shown here, the base element 13 is designed as a preform 13b. A plurality of edges 29 is incorporated in the preform 13b. The edges 29 form a preform structure on the upper side 23 of the preform 13b 30 (relief). The heating apparatus 14 in the embodiment shown is designed with radiant heaters 14b. The heaters 14b are arranged in the gas-tight build chamber 2 and aligned with the upper side 23 of the base element 13. The radiation (infrared radiation) of the heaters 14b is shown as wavy curves.

In the embodiment of FIG. 2, the working laser 17 can, as a laser beam 18, besides the preparation laser beam (not shown in detail here) and the processing laser beam (also not shown in detail), also have a measuring laser beam 18b (solid line). The upper side 23 of the base element 13 can be scanned with the measuring laser beam 18b. In the embodiment shown here, the laser beam 18 is guided via a semi-transparent mirror 31 and from there to the scanner device 19 of the working laser 17.

According to embodiments of the invention, before the layered manufacturing of the object on the base element 13 is started, the surface 22 on the upper side 23 of the base element 13 in the treatment region 21 is roughened with the working laser 17.

Furthermore, according to embodiments of the invention, after roughening the treatment region 21 of the base element 13, the measurement pattern 24 is measured. In the example shown here, the measurement pattern 24 is an edge structure 24b of the base element 13. The edge structure 24b here corresponds to a part of the preform structure 30. The edges 29 of the edge structure 24b are all encompassed (enclosed) by the roughened treatment region 21 of the base element 13. Only by roughening the surface 22 of the preform 13b does the edge structure 24a become sufficiently clearly discernible (in other words, the contrast of the edge structure 24a becomes better), so that the edge structure 24b can be easily detected and processed, for example, by an image processing algorithm. In the preliminary measurement, the measurement pattern 24 on the upper side 23 of the base element 13 is measured by the measuring device 26. In the embodiment shown here, the measuring device 26 comprises a zero-dimensional photodetector 32, which is designed as a photodiode 32a.

For the preliminary measurement, the measuring laser beam 18b is guided via the scanner device 19 of the working laser 17 to the upper side 23 of the base element 13. The measuring laser beam 18b impinges on an impingement point 33. From the impingement point 33, laser light 34 (dotted lines) is scattered back into the scanner device 19 of the working laser 17. From there, the backscattered laser light 34 is guided to the semi-transparent mirror 31. The semi-transparent mirror 31 is partially transparent to the backscattered laser light 34 so that some of the backscattered laser light 34 impinges through the semi-transparent mirror 31 on a focusing lens 35. The focusing lens 35 focuses the backscattered laser light 34 onto the zero-dimensional photodetector 32. The upper side 23 of the base element 13 can be scanned by a large number of repetitions of these individual measurements at further impingement points 33 (corresponding to different positions of the movable mirror 19a of the scanner device 19), and an image of the measurement pattern 24 can be obtained by combining these individual measurements.

The measurement data of the photodetector 32 are transmitted to the control unit 28 and processed. In particular, the data from the preliminary measurement may comprise information about the three-dimensional structures of the base element 13 or about the position of the three-dimensional structures relative to the piston plate 12 or to the system 1.

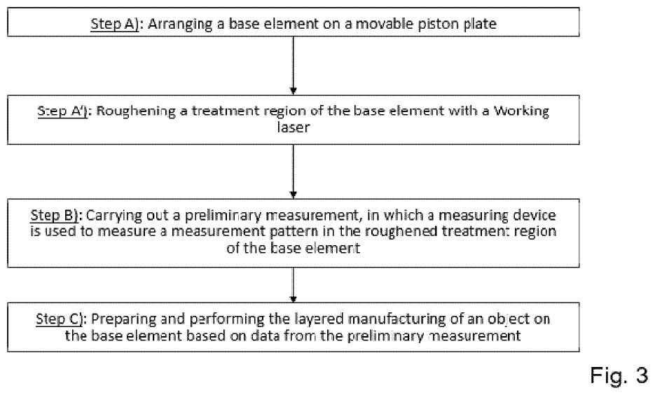

FIG. 3 explains in a flow chart the sequence of a first variant of the method according to embodiments of the invention for the layered manufacturing of an object on a base element, as can be carried out for example in the system of the first embodiment in FIG. 1.

At the start, in a step A), the base element is arranged on a movable piston plate of the system. For this purpose, the movable piston plate and the base element can be arranged in a gas-tight build chamber of the system.

In a next step A′), treatment region of the base element is roughened. The roughening of the treatment region is carried out by means of a working laser, which provides a preparation laser beam with which the treatment region of the base element can be roughened.

In a subsequent step B), a preliminary measurement is carried out in the system. For this purpose, a measurement pattern is measured on the upper side of the base element. The measurement is carried out using a measuring device, for example a camera or a photodiode. Only the roughening of the surface of the base element makes it possible for the measurement pattern to be projected onto the upper side of the base element as a clearly discernible light pattern and measured with the measuring device, or for the measurement pattern to be measured as a clearly discernible edge structure of the base element with the measuring device.

Note that during steps A′) and B) the base element can be preheated by means of a heating apparatus. Likewise, if the system has a gas-tight build chamber, a protective gas atmosphere can be configured in the gas-tight build chamber during steps A′) and B).

In a final step C), the layered manufacturing of the object is prepared and carried out. This preparation and implementation is carried out on the basis of the data from the preliminary measurement.

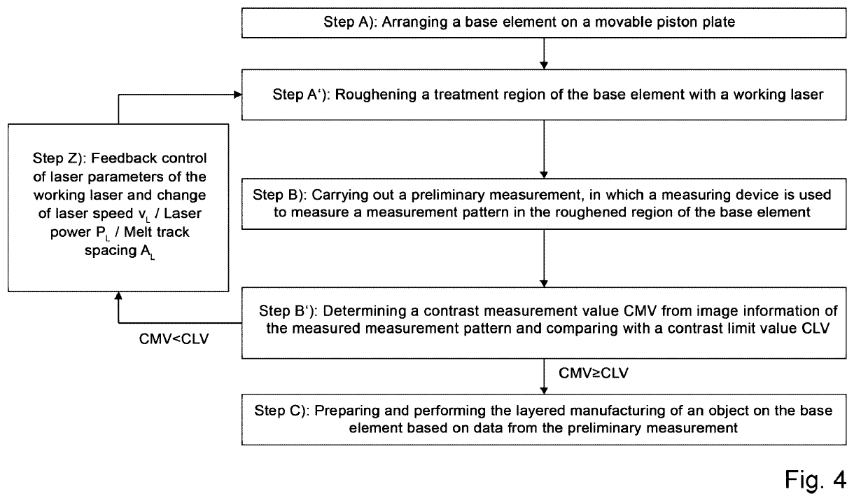

FIG. 4 explains in a flow chart the sequence of a second variant of the method according to embodiments of the invention for the layered manufacturing of an object on a base element, as can be carried out for example in the system of the first embodiment in FIG. 1. Steps A), A′), B) and C) are identical to the flow chart in FIG. 3. Therefore, only the differences are explained in FIG. 4.

In the variant shown here, another step B′) takes place between step B) and step C). The data from the preliminary measurement contain image information of the measured measurement pattern. In step B′), a contrast measurement value CMV is determined for the image information of the measured measurement pattern, following which the contrast measurement value CMV is compared with a contrast limit value CLV. In this way, it can be determined whether the contrast of the measured measurement pattern and thus the data from the preliminary measurement are good enough so that, for example, an image processing algorithm can process the data from the preliminary measurement in order to prepare and carry out the manufacturing of at least one object on the base element. If CMV≥CLV, the process continues with step C). If, however, CMV<CLV, the process continues with step Z).

In step Z), feedback control is carried out. During feedback control, the data from the current preliminary measurement (for example at the level of the image information or the contrast measurement value) are compared with a comparison value (for example from previous preliminary measurements, or the specified contrast limit value, CLV) and an estimate is made as to whether the last selected manufacturing parameters or the last applied change to the manufacturing parameters have brought about a (desired) improvement or not. If necessary, the manufacturing parameters are then changed to further improve the contrast measurement value in a next step A′). In particular, a laser speed v_{L} and/or a laser power P_{L} and/or a melt track spacing A_{L} of the working laser can be changed. After setting the laser parameters, steps A′), B) and B′) are carried out again and, at the end of step B′), it is checked whether the process can be continued with step C) or whether steps Z), A′), B) and B′) need to be repeated.

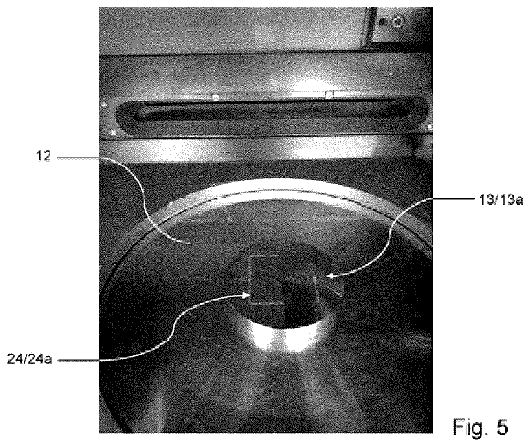

FIG. 5 shows an experimental photo of a base element 13, which is formed as a flat substrate plate 13a and is arranged on a piston plate 12. According to the method according to embodiments of the invention, the left half of the flat substrate plate 13a (shown in FIG. 5) was roughened with the working laser. The measurement pattern 24 to be measured is projected as a (here square) light pattern 24a onto the upper side of the flat substrate plate 13a. The light pattern 24a is clearly discernible on the left half of the flat substrate plate 13a. On the right half of the flat substrate plate 13a, which has not been roughened, the light pattern is largely indiscernible at all or only very weakly discernible.

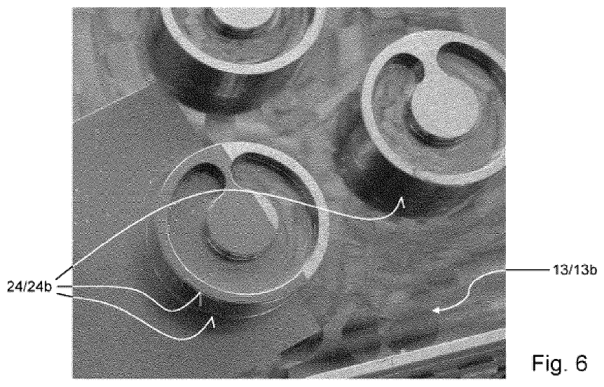

FIG. 6 shows an experimental photo of a base element 13, which is formed as a preform 13b with a preform structure. According to the method according to embodiments of the invention, a section of the preform 13b in the left region was roughened with the working laser. The measurement pattern 24 to be measured here comprises an edge structure 24b, and the preform structure partially serves as the edge structure 24b. The edge structure 24b is clearly discernible in the left region of the preform 13b, which was roughened by the working laser. In the regions that have not been roughened, the edge structure 24b is difficult to discern, and highlights (light reflections) and other reflections overlay the contrast. In addition, roughening leads to a disappearance of the milling marks on the base element 13, which is also advantageous for applications with image processing, regardless of highlights.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 System
2 Gas-tight build chamber
3 Powder cylinder arrangement
4 Powder cylinders
5 Pulverulent material
6 Powder piston
7 First lifting device
8 Bottom (of the gas-tight build chamber)
9 Slider
10 Build cylinder arrangement
11 Collecting container
12 (Movable) piston plate
13 Base element
13a Flat substrate plate
13b Preform
14 Heating apparatus
14a Heating coil
14b Radiant heater
15 Main body
16 Second lifting device
17 Working laser
18 Laser beam
18a Preparation laser beam
18b Measuring laser beam
19 Scanner device
19a Movable mirror
20 Window
21 Treatment region
22 Surface (of the base element)
23 Upper side (of the base element)
24 Measurement pattern
24a Light pattern
24b Edge structure
25 Projector
26 Measuring device
27 Camera
28 Control unit
29 Edge
30 Preform structure
31 Semi-transparent mirror
32 Zero-dimensional photodetector
32a Photodiode
33 Impingement point
34 (Backscattered) laser light
35 Focusing lens
A_{L} Melt track spacing (of the working laser)
CLV Contrast limit value
CMV Contrast measurement value
P_{L} Laser power (of the working laser)
v_{L} Laser speed (of the working laser)

1. A method for operating a system for layered manufacturing of at least one object on a base element by locally consolidating pulverulent material in a layer with a working laser, the method comprising:
A) arranging the base element on a movable piston plate,
B) carrying out a preliminary measurement in the system, wherein a measurement pattern on an upper side of the base element is measured using a measuring device,
C) based on data from the preliminary measurement, preparing and carrying out the layered manufacturing of the at least one object on the base element, and
A′), after the step A) and before the step B), in a treatment region of the base element, roughen a surface of the base element facing the working laser with the working laser in the system, the treatment region comprising at least a part of the upper side of the base element,
wherein in the step B), the measurement pattern to be measured comprises:
a light pattern which is at least partially projected into the roughened treatment region on the upper side of the base element, and/or
an edge structure on the upper side of the base element with a plurality of edges, wherein at least a part of the plurality of edges of the edge structure is in the roughened treatment region.

2. The method according to claim 1, further comprising:
B′), after the step B), for image information of the measured measurement pattern which is contained in the data from the preliminary measurement, determining a contrast measurement value (CMV) and comparing the CMV with a contrast limit value (CLV),
and the steps A′), B), and B′) are repeated upon determining that CMV<CLV.

3. The method according to claim 2, further comprising, by repeating the steps A′), B), and B′), carrying out a feedback control) of laser parameters of the working laser during the roughening of the surface facing the working laser in the step A′).

4. The method according to claim 2, wherein when repeating the step A′), a laser speed v_{L}, and/or a laser power P_{L}, and/or a melt track spacing A_{L} of the working laser is changed with respect to a previous step A′).

5. The method according to claim 1, wherein the system comprises a heating apparatus for the base element, the method further comprising preheating the base element using the heating apparatus before starting the layered manufacturing of the at least one object, wherein the steps A′) and B) are performed during the preheating the base element.

6. The method according to claim 1, wherein the system comprises a gas-tight build chamber, the method further comprising configuring a protective gas atmosphere in the gas-tight build chamber before starting the layered manufacturing of the at least one object, wherein the steps A′) and B) are performed during the configuring the protective gas atmosphere.

7. The method according to claim 1, wherein the measuring device comprises a camera, wherein during the preliminary measurement, the camera records at least one image of the measurement pattern on the upper side of the base element.

8. The method according to claim 1, wherein
the measuring device comprises a zero-dimensional photodetector,
the measuring device is configured to also use the working laser and a scanner device of the working laser, and
the measuring device is configured to record at least one image of the measurement pattern on the upper side of the base element by scanning the upper side of the base element with a measuring laser beam generated by the working laser and detecting laser light which is backscattered from an impingement point of the measuring laser beam on the upper side of the base element through the scanner device into the zero-dimensional photodetector.

9. The method according to claim 1, wherein the data from the preliminary measurement comprise information about
a position of the base element relative to the piston plate or to a rest of the system and/or
a tilting of the base element relative to the piston plate or to the rest of the system and/or
three-dimensional structures of the base element.

10. The method according to claim 1, wherein the base element is configured as a flat substrate plate.

11. The method according to claim 1, wherein the base element is configured as a preform, wherein a preform structure is incorporated into the preform on the upper side of the base element with a plurality of edges,
wherein the preform structure is used at least partially as the edge structure of the measurement pattern to be measured.

12. A system for layered manufacturing of at least one object on a base element by locally consolidating pulverulent material in a layer with a working laser,
configured to carry out a method according to claim 1.
